(19) United States
(12) Patent Application Publication
(10) Pub. No.: US 2025/0334101 A1
(43) Pub. Date: Oct. 30, 2025

(54) ANOMALY DATA DETERMINATION FOR TURBINE BLADES OF A WIND TURBINE

(71) Applicants: ACWA POWER Company, Riyadh (SA); Indian Institute of Technology Delhi, New Delhi (IN)

(72) Inventors: Madhusudan SINGH, New Delhi (IN); Nilanjan SENROY, New Delhi (IN); Mohammad ANSARI, Dubai (AE)

(73) Assignees: ACWA POWER Company, Riyadh (SA); Indian Institute of Technology Delhi, New Delhi (IN)

(21) Appl. No.: 19/190,526

(22) Filed: Apr. 25, 2025

Related U.S. Application Data
(60) Provisional application No. 63/639,480, filed on Apr. 26, 2024.

(51) Int. Cl. F03D 17/00; F03D 7/04

(52) U.S. Cl. CPC F03D 17/013; F03D 7/042; F03D 17/028; F05B 2270/402

(57) ABSTRACT

The present disclosure provides a system and method for real-time anomaly data determination for turbine blades of a wind turbine. The system receives sensor data associated with a set of turbine blades of the wind turbine. The sensor data indicates one or more structural characteristics associated with each of the set of turbine blades and/or one or more operational characteristics associated with each of the set of turbine blades. The system determines profile data associated with each of the set of turbine blades based on the sensor data. The system determines anomaly data associated with at least one of the set of turbine blades based on the profile data associated with each of the set of turbine blades. The anomaly data indicates a deviation between at least two turbine blades of the set of turbine blades. The system outputs the anomaly data.

### CROSS-REFERENCE TO RELATED APPLICATION

This application claims priority to U.S. Provisional Patent Application Ser. No. 63/639,480, filed Apr. 26, 2024 and entitled REAL-TIME MONITORING OF WIND TURBINE BLADES USING OPTOELECTRONIC MEANS, the disclosure which is incorporated herein by reference.

### TECHNICAL FIELD

The present disclosure relates to wind turbines. More specifically, various embodiments of the present disclosure relate to anomaly data determination for turbine blades of wind turbines.

### BACKGROUND

Wind energy has emerged as a prominent and sustainable source of power, with wind turbines being widely deployed to harness kinetic energy from the wind and convert it into electricity. Modern wind turbines typically consist of multiple turbine blades attached to a central hub, and these turbine blades are subject to various environmental conditions, such as wind gusts, turbulence, and temperature fluctuations. Over time, these conditions may lead to structural fatigue, wear, and deflections in the turbine blades, affecting both the performance and safety of the entire wind turbine.

Furthermore, modern wind turbines may be characterized by large rotor diameters, optimizing cost for enhanced efficiency. The important role of turbine blades in converting mechanical energy to electrical power underscores the critical importance of aerodynamic balancing, particularly with the increased scale of rotor diameters. The design of turbine blades, featuring highly sensitive aerodynamic profiles, is imperative. Misalignment of a turbine blade, such as even a small mismatch of the aerodynamic profile, may significantly impact lift generation and overall thrust, thereby compromising the performance of the wind turbine. Beyond performance concerns, misalignments pose risks to aerodynamic force stability across swept areas, potentially leading to structural oscillations, vibrations, and in some cases, turbine blade failure or wind turbine failure. Current instrumentation checks on the turbine blades are minimally effective with stud hardware fixing introducing potential aerodynamic profile mismatches.

Existing methods for monitoring turbine blades often involve data collection from various sensors, periodic manual inspections, and manual assessments. However, these approaches may not provide real-time insights into the dynamic behavior of the turbine blades, potentially leading to operational inefficiencies, increased maintenance costs, and, in some cases, structural failures.

Therefore, there is a need for continuous and accurate monitoring of deviations or anomalies in turbine blades in real-time.

### SUMMARY OF THE INVENTION

The present disclosure may provide a system and a method for anomaly data determination for the turbine blades of a wind turbine. In one aspect, a system for real-time anomaly data determination for turbine blades is disclosed. The system includes a memory configured to store a computer-executable instructions. The system further includes one or more processors configured to execute the computer-executable instructions to receive sensor data associated with a set of turbine blades of a wind turbine from one or more sensors. The sensor data indicates at least one of: one or more structural characteristics associated with each of the set of turbine blades, or one or more operational characteristics associated with each of the set of turbine blades. The one or more processors may be further configured to determine profile data associated with each of the set of turbine blades based on the sensor data. The one or more processors may be further configured to determine anomaly data associated with at least one of the set of turbine blades based on the profile data associated with each of the set of turbine blades. The anomaly data indicates a deviation between at least two turbine blades of the set of turbine blades. The one or more processors may be further configured to output the anomaly data.

According to an additional system embodiment, the set of turbine blades includes at least a first turbine blade and a second turbine blade. Further, the one or more processors may be configured to determine first profile data associated with the first turbine blade based on the sensor data. The one or more processors may be further configured to determine second profile data associated with the second turbine blade based on the sensor data. The one or more processors may be further configured to compare the first profile data with the second profile data. The one or more processors may be further configured to determine the anomaly data based on the comparison between the first profile data and the second profile data. The anomaly data indicates the deviation in at least one of the first turbine blade or the second turbine blade.

According to an additional system embodiment, the one or more processors may be further configured to obtain historical profile data associated with each of the set of turbine blades. The historical profile data indicates one or more historical aerodynamic parameters associated with each of the set of turbine blades. The one or more processors may be further configured to compare the profile data associated with each of the set of turbine blades with the corresponding historical profile data. The one or more processors may be further configured to determine the anomaly data associated with at least one of the set of turbine blades based on the comparison between the profile data and the historical profile data.

According to an additional system embodiment, the one or more processors are further configured to generate control data associated with an operation of the wind turbine. The control data is generated based on the anomaly data. The one or more processors are further configured to control the operation of the wind turbine based on the control data.

According to an additional system embodiment, the profile data indicates one or more aerodynamic parameters associated with each of the set of turbine blades.

According to an additional system embodiment, the one or more processors are further configured to obtain one or more threshold aerodynamic parameters associated with each of the set of turbine blades. The one or more processors are further configured to compare the one or more aerodynamic parameters associated with each of the set of turbine blades with the corresponding one or more threshold aerodynamic parameters. The one or more processors are further configured to determine the anomaly data associated with at least one of the set of turbine blades based on the comparison between the one or more aerodynamic parameters and the one or more threshold aerodynamic parameters.

According to an additional system embodiment, the anomaly data indicates the deviation in at least one of the one or more aerodynamic parameters associated with at least one of the set of turbine blades.

According to an additional system embodiment, the one or more structure characteristics correspond to at least one of: a dimension associated with each of the set of turbine blades, a curvature associated with each of the set of turbine blades, or one or more material parameters associated with each of the set of turbine blades.

According to an additional system embodiment, the one or more operational characteristics correspond to at least one of: a stress associated with each of the set of turbine blades, a strain associated with each of the set of turbine blades, an operational temperature associated with the wind turbine, a vibration level associated with each of the set of turbine blades, a deflection associated with each of the set of turbine blades, a twist angle associated with each of the set of turbine blades, a power output associated with the wind turbine, a wind speed associated with the wind turbine, a turbulence associated with the wind turbine, a yaw associated with the wind turbine, an oscillation of a tower associated with the wind turbine, or a pitch angle associated with each of the set of turbine blades.

According to an additional system embodiment, the one or more sensors includes at least one of: a Light Detection and Ranging (LIDAR) sensor, or a Light amplification by stimulated emission of radiation (LASER) sensor.

According to an additional system embodiment, the one or more sensors are mounted on the ground proximal to the wind turbine.

According to an additional system embodiment, the one or more sensors are integrated within an aerial vehicle.

In another aspect, a method for real-time anomaly data determination for turbine blades of a wind turbine is disclosed. The method includes receiving sensor data associated with a set of turbine blades of a wind turbine. The sensor data indicates at least one of: one or more structural characteristics associated with each of the set of turbine blades, or one or more operational characteristics associated with each of the set of turbine blades. The method further includes determining profile data associated with each of the set of turbine blades based on the sensor data. The method further includes determining anomaly data associated with at least one of the set of turbine blades based on the profile data associated with each of the set of turbine blades. The anomaly data indicates a deviation between at least two turbine blades of the set of turbine blades. The method further includes outputting the anomaly data.

According to an additional method embodiment, the set of turbine blades includes at least a first turbine blade and a second turbine blade. The method further includes determining the first profile data associated with the first turbine blade based on the sensor data. The method further includes determining second profile data associated with the second turbine blade based on the sensor data. The method further includes comparing the first profile data with the second profile data. The method further includes determining the anomaly data based on the comparison between the first profile data and the second profile data. The anomaly data indicates the deviation in at least one of the first turbine blade or the second turbine blade.

According to an additional method embodiment, the method further includes obtaining historical profile data associated with each of the set of turbine blades. The historical profile data indicates one or more historical aerodynamic parameters associated with each of the set of turbine blades. The method further includes comparing the profile data associated with each of the set of turbine blades with the corresponding historical profile data. The method further includes determining the anomaly data associated with at least one of the set of turbine blades based on the comparison between the profile data and the historical profile data.

According to an additional method embodiment, the method further includes generating control data associated with the operation of the wind turbine. The control data is generated based on the anomaly data. The method further includes controlling the operation of the wind turbine based on the control data.

According to an additional method embodiment, the profile data indicates one or more aerodynamic parameters associated with each of the set of turbine blades.

According to an additional method embodiment, the method further includes obtaining one or more threshold aerodynamic parameters associated with each of the set of turbine blades. The method further includes comparing the one or more aerodynamic parameters associated with each of the set of turbine blades with the corresponding one or more threshold aerodynamic parameters. The method further includes determining the anomaly data associated with at least one of the set of turbine blades based on the comparison between the one or more aerodynamic parameters and the one or more threshold aerodynamic parameters.

According to an additional method embodiment, the anomaly data indicates the deviation in at least one of the one or more aerodynamic parameters associated with at least one of the set of turbine blades.

In yet another aspect, a computer programmable product for real-time anomaly data determination for turbine blades of a wind turbine is disclosed. The computer programmable product includes a non-transitory computer readable medium having stored thereon computer executable instructions. The computer executable instructions when executed by one or more processors, cause the one or more processors to carry out operations. The operations include receiving sensor data associated with a set of turbine blades of a wind turbine. The sensor data indicates at least one of: one or more structural characteristics associated with each of the set of turbine blades, or one or more operational characteristics associated with each of the set of turbine blades. The operations further include determining profile data associated with each of the set of turbine blades based on the sensor data. The operations further include determining anomaly data associated with at least one of the set of turbine blades based on the profile data associated with each of the set of turbine blades. The anomaly data indicates a deviation between at least two turbine blades of the set of turbine blades. The operations further include outputting the anomaly data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram that illustrates an environment for real-time anomaly data determination for turbine blades of a wind turbine, in accordance with an embodiment of the disclosure;

FIG. 2 is an exemplary block diagram of the system of FIG. 1, in accordance with an example embodiment;

FIG. 3. illustrates a flowchart of a method for determining anomaly data associated with at least one of the set of turbine blades, in accordance with an example embodiment; and

FIG. 4. illustrates a flowchart of a method for controlling an operation of a wind turbine, in accordance with an example embodiment.

### DETAILED DESCRIPTION

In the following description, for purposes of explanation, numerous specific details may be set forth in order to provide a thorough understanding of the present disclosure. It will be apparent, however, to one skilled in the art that the present disclosure may be practiced without these specific details. In other instances, systems and methods may be shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

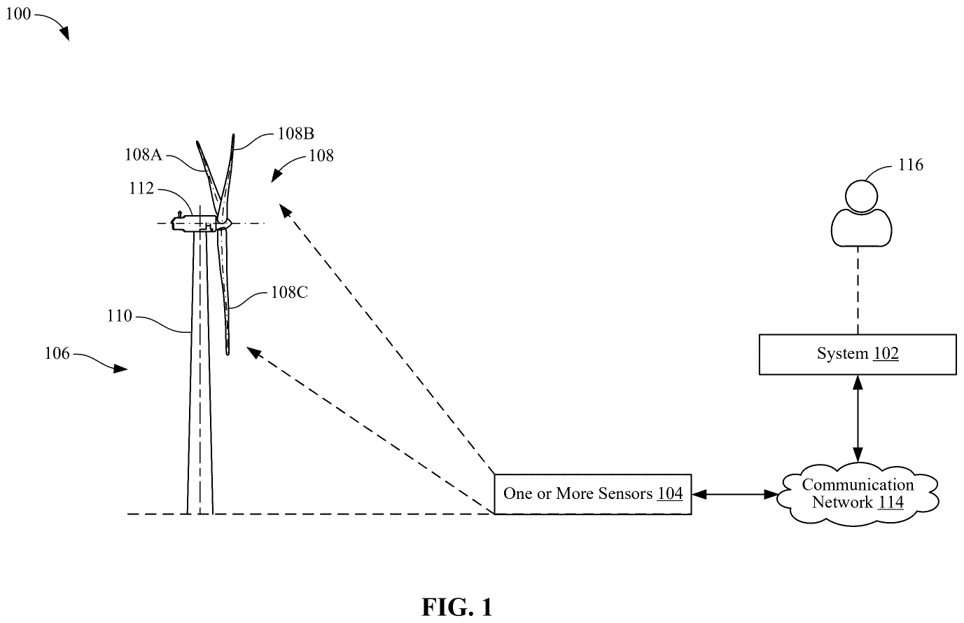

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 4, a brief description concerning the various components of the present disclosure will now be briefly discussed.

In a wind turbine, a set of turbine blades are used for generating electrical energy. It is of great importance that each turbine blade is similar in shape, weight, and pitch, since any difference may result in unwanted stresses and loads during an operation of the wind turbine depending upon a current angular position of the wind turbine.

Wind turbines are critical of the renewable energy sector, converting kinetic energy from wind into mechanical power that can then be used to generate electricity. For a wind turbine to operate efficiently, turbine blades are carefully designed and manufactured to ensure uniformity and balance. However, even with rigorous design and quality control processes, mismatches between turbine blades are a persistent challenge in wind turbine performance.

The efficiency of a wind turbine is heavily dependent on aerodynamic properties of the turbine blades of the wind turbine. Each wind turbine is typically designed with turbine blades that are identical in size, shape, and weight. Any deviation or discrepancy in the aerodynamic properties, for example, that may be caused by manufacturing tolerances, manufacturing testing deviation, material degradation over time, assembly process, or environmental factors, may result in blade profile mismatch during operation. Further, variations in blade shape or surface texture may lead to uneven airflow across the turbine blades, causing them to generate different amounts of lift or drag. This can result in oscillations, reduced power output, and increased load on certain turbine components. In certain cases, even slight differences in the profile exposure during operation of the turbine blades can lead to uneven rotational inertia, causing vibrations or irregular spinning patterns.

Over time, these irregularities can lead to mechanical stresses, premature wear, or even structural damage to the turbine. In an example, environmental conditions such as UV exposure, high wind speeds, or temperature fluctuations can degrade the material properties of the turbine blades over time. Uneven wear across surfaces of the turbine blades, or differences in how individual turbine blades respond to weathering, may also cause mismatch, further degrading turbine performance. The consequences of blade mismatch are significant and can affect several aspects of turbine performance and longevity. A mismatch in blade characteristics, such as aerodynamic imbalance or differences in rotational speed, can reduce the amount of wind energy that is effectively converted into electricity. Even slight differences in blade performance can lead to a measurable decrease in overall energy output, which translates to a loss in the turbine's efficiency.

Further, blade mismatch can introduce additional mechanical stresses on the turbine's drive train, bearings, and other internal components. Over time, these stresses can lead to premature failure of critical parts, necessitating costly repairs and increasing downtime. Mismatched blades often require more frequent inspections, adjustments, or replacements. The added complexity of diagnosing and correcting mismatch-related issues increases the maintenance burden and costs for wind turbine operators. The cumulative effect of mechanical stress and reduced efficiency can shorten the lifespan of wind turbines. Parts may need to be replaced more often, and the entire wind turbine may have to be decommissioned sooner than expected due to cumulative damage.

For example, the rotors may have a diameter more than or equal to 200 meters. An imbalanced loading in a rotating frame acting on at least some known rotors may occur due to mass imbalance in the turbine blades, geometrical irregularities in rotor and/or turbine blade mounting, differences in aerodynamic geometry (section, bend, and/or twist) between the turbine blades, and/or differences in pitch angle zero point between the turbine blades. Such imbalanced loads acting on the wind turbine rotor may be induced by other components of the wind turbine, which may have an impact on several fatigue cycles that certain components of the wind turbine experience. For example, imbalanced loads acting on the rotor of the wind turbine may facilitate fatigue damage of a bedplate that connects a tower of the wind turbine to the ground, may facilitate damage to and/or failure of portions of a nacelle of the wind turbine, and/or may facilitate damage to and/or failure of other components of the wind turbine, such as, but not limited to, main shaft bearings, a yaw system of the wind turbine, and/or the wind turbine tower.

Conventionally, addressing the wind turbine blade mismatch involves a combination of analysing the operation data, identifying the probable cause linked with mismatch, visual inspection, manual adjustments, and occasional wind turbine blade replacement. Visual inspections may be conducted regularly, with a technician visually assessing the alignment of the wind turbine blades to identify any visible deviations, it is mostly achieved by the secondary behaviour or consequences observed in wind turbine by analysing operation data. However, this approach has limitations, especially with large rotor diameters, as subtle misalignments may not be easily visible. Moreover, the manual adjustment process is time-consuming, inaccurate (trial and test method) and may require turbine shutdowns, impacting overall energy production. In more severe cases, where the balance persists or results in structural issues, complete wind turbine blade replacements become necessary, incurring significant costs and downtime. The conventional method relies heavily on human intervention and lacks real-time monitoring capabilities, making it less efficient for modern wind turbines.

To this end, there exists a need for a system and method that can automatically detect blade mismatch in wind turbines in real time, without requiring constant human intervention, which is still lacking in the industry.

Embodiments of the present disclosure provide system and methods to overcome the reliance on human intervention for detecting aerodynamic profile mismatches. The present disclosure provides the system and the method to autonomously identify and quantify deviation in the aerodynamic profiles, ensuring a more efficient and a proactive approach. The system and method offer a reliable solution for real-time identification of aerodynamic profile deviation in the wind turbine blades.

The embodiments of the present disclosure provide the system and the method for automatically determining anomaly data associated with the turbine blades of a wind turbine. The anomaly data may indicate blade mismatch among the turbine blades of the wind turbine. Accurate and real-time determination of the anomaly data, such as the blade mismatch, ensures consistent energy production and reduces strain on the mechanical components of the wind turbine. The system for anomaly data determination can be integrated seamlessly with existing wind turbine infrastructure, require minimal maintenance, and provide a cost-effective way to extend an operational life of turbine blades, thereby contributing to more sustainable and reliable wind energy production.

FIG. 1 is a diagram that illustrates an environment for real-time anomaly data determination for turbine blades of a wind turbine, in accordance with an embodiment of the disclosure. With reference to FIG. 1, there is shown a diagram of a network environment 100. The network environment 100 includes a system 102, one or more sensors 104, a wind turbine 106, a set of turbine blades 108, a wind turbine tower 110, and a wind turbine rotor 112. The set of turbine blades 108 may include a first turbine blade 108A, a second turbine blade 108B, and a third turbine blade 108C. With reference to FIG. 1, there is further shown communication network 114 and user 116.

The system 102 may include suitable logic, circuitry, interfaces, and/or code that may be configured to determine the anomaly data associated with the set of turbine blades 108 of the wind turbine 106. In this regard, the system 102 may be configured to determine the profile data of each of the set of turbine blades 108. Further, the system 102 may be configured to compare the profile data of each of the set of turbine blades 108 with each other and determine the anomaly data in at least one of the set of turbine blades 108. For example, the anomaly data may indicate a deviation in an aerodynamic profile of at least one of the set of turbine blades 108. Further, the determined anomaly data is output. Example of the system 102 may include, but not limited to, a computing device, a mainframe machine, a server, a computer workstation, a smartphone, a cellular phone, a mobile phone, a gaming device, and/or a consumer electronic (CE) device.

The one or more sensors 104 may include suitable logic, circuitry, interfaces, and/or code that may be configured to capture sensor data associated with each turbine blade of the set of turbine blades 108. The one or more sensors 104 may be configured to perform a comprehensive assessment, gathering data related to individual structural characteristics of each turbine blade of the set of turbine blades 108. This entails capturing essential parameters such as dimensions, curvature, and material integrity. The one or more sensors 104 operate collectively to collect the sensor data. In an example, the sensor data may provide a holistic view of the structural attributes of each of the set of turbine blades 108. The one or more sensors 104 may be configured to ensure precise and thorough data acquisition, enabling a comprehensive understanding of the structural dynamics of each turbine blade of the set of turbine blades 108. For example, the one or more sensors 104 may include a Light Detection and Ranging (LIDAR) sensor or a Light amplification by stimulated emission of radiation (LASER) sensor.

The wind turbine 106 may be a device that converts the kinetic energy of wind into electrical energy. The wind turbine 106 may be used to generate electricity for homes, businesses, or grids. The electricity produced by the wind turbine 106 may depend on several factors, such as wind speed, air density, turbine blade design, and generator efficiency. The wind turbine 106 may have several advantages over other sources of electricity, such as fossil fuels or nuclear power. The wind turbine 106 is renewable, cost-effective, and may also be installed in remote areas, where access to the grid may be limited or expensive. Further the wind turbine 106 may include components such as the set of turbine blades 108, the wind turbine tower 110, and the wind turbine rotor 112.

The set of turbine blades 108 may include the first turbine blade 108A, the second turbine blade 108B, and the third turbine blade 108C attached to the wind turbine rotor 112 of the wind turbine 106. The set of turbine blades 108 may be responsible for harnessing wind energy and converting it into rotational motion, driving the wind turbine rotor 112 to produce electricity. The material used in constructing the set of turbine blades 108 may be chosen to ensure a balance of strength, durability, and aerodynamic efficiency. Examples of the commonly employed materials include fiberglass reinforced with epoxy or polyester resin, carbon fibers, and the like.

One of the most important aspects of each of the set of turbine blades 108 is the aerodynamic profile of the turbine blades. The aerodynamic profile of a turbine blade may determine how the turbine blade interacts with the airflow, and produces lift, and drag forces. The aerodynamic profile may have a high lift-to-drag ratio, which means that it may generate more lift force than drag force at a given wind speed and angle of the wind. This results in a higher rotational speed and a higher power output of the set of turbine blades 108. Additionally, the optimal aerodynamic profile may also have a low noise emission, high structural strength, and a long service life. Such factors depend on the shape, size, material, and surface quality of the set of turbine blades 108. Therefore, optimizing the aerodynamic profile of the set of turbine blades 108 may be essential for improving the performance and sustainability of the wind turbine 106.

The wind turbine tower 110 may be the structure that supports the set of turbine blades 108 and the wind turbine rotor 112. The wind turbine tower 110 may be the component for the performance and efficiency of the wind turbine 106, as it determines the height and exposure of the set of turbine blades 108 to the wind. The wind turbine tower 110 may also withstand the mechanical stresses and vibrations caused by the wind and the rotating set of turbine blades 108. Therefore, the wind turbine tower 110 design and material selection are important factors for the stability and durability of the wind turbine 106. Examples of different types of the wind turbine tower 110 may include, but are not limited to, a tubular steel tower, a lattice tower, a concrete tower, or a hybrid tower. The choice of the wind turbine tower 110 depends on several factors, such as the site conditions, the wind turbine size, the transportation and installation costs, and the environmental impact.

The wind turbine rotor 112 may be the part of the wind turbine 106 that converts the rotational energy of the set of turbine blades 108 into the mechanical energy that produces electricity. The wind turbine rotor 112 includes the set of turbine blades 108 that may be attached to a hub of the wind turbine rotor 112. The set of turbine blades 108 may be shaped to capture the wind and create lift, which causes the wind turbine rotor 112 to spin. The hub may be connected to a shaft that transfers the rotational motion to the wind turbine rotor 112, where electricity may be produced. The wind turbine rotor 112 may be the component of the wind turbine 106, as it determines the amount of power that may be extracted from the wind.

The communication network 114 may include a communication medium through which the system 102 and the one or more sensors 104 may communicate with each other. The communication network 114 may be one of a wired connection or a wireless connection. Examples of the communication network 114 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 114 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), a device to device communication, cellular communication protocols, and Bluetooth (BT) communication protocols.

In operation, the system is configured to receive sensor data associated with the set of turbine blades 108 of the wind turbine 106 using the one or more sensors 104. In an example, the sensor data indicates one or more structural characteristics associated with each of the set of turbine blades 108 and/or one or more operational characteristics associated with each of the set of turbine blades 108. For example, the user 116 may initiate a command to the system 102, instructing the system 102 to perform an assessment of the aerodynamic profiles of each turbine blade of the set of turbine blades 108 and identify any anomaly or deviation in the set of turbine blades 108. The command prompts of the system 102 to activate the one or more sensors 104 and analytical processes, enabling a thorough examination of the aerodynamic profile of each turbine blade of the set of turbine blades 108 within the wind turbine 106. The objective may be to detect any deviations or inconsistencies in the aerodynamic profiles of the set of turbine blades 108, providing the user 116 with valuable insights into the overall health and efficiency of the wind turbine 106.

Based on the reception of the command, the system 102 may control the one or more sensors 104 to capture the sensor data. The sensor data may indicate the one or more structural characteristics associated with each of the set of the turbine blades 108 of the wind turbine 106. The one or more structural characteristics may include various parameters, including a dimension, a curvature, and material characteristics of each of the set of turbine blades 108. The sensor data may also indicate the one or more operational characteristics associated with each of the set of the turbine blades 108 of the wind turbine 106. The one or more operational characteristics may include various parameters, including a current power output, a lift associated with each turbine blade of the set of turbine blades 108, a drag associated with each turbine blade of the set of turbine blades 108, stress, strain, temperature, and vibration levels. The one or more sensors 104 operate harmoniously, capturing precise and relevant structural characteristics and/or operational characteristics essential for subsequent analyses.

In an example, the one or more structural characteristics correspond to, but is not limited to, a dimension associated with each of the set of turbine blades 108, a curvature associated with each of the set of turbine blades 108, or one or more material parameters associated with each of the set of turbine blades 108. The dimension associated with a turbine blade may define the geometric scale and proportions of the turbine blade, such as blade length, chord length, blade width, blade thickness, taper ratio, and aspect ratio. The curvature associated with the turbine blade may define the shape of the turbine blade which influences its aerodynamic behavior. The curvature may be defined using, for example, camber, twist angle, pitch angle, edge curvature, and surface contour and sculpting. The one or more material parameters associated with the turbine blade may define, for example, type of material, material composition, density, Young's modulus, tensile strength, fatigue resistance, thermal expansion coefficient, environmental resistance, and layering configuration.

In an example, the one or more operational characteristics correspond to, but are not limited to, a stress associated with each of the set of turbine blades 108, a strain associated with each of the set of turbine blades 108, an operational temperature associated with the wind turbine 106, a vibration level associated with each of the set of turbine blades 108, a deflection associated with each of the set of turbine blades 108, a twist angle associated with each of the set of turbine blades 108, a power output associated with the wind turbine 106, a wind speed associated with the wind turbine 106, a turbulence associated with the wind turbine 106, a yaw associated with the wind turbine 106, an oscillation of the wind turbine tower 110 associated with the wind turbine 106, and a pitch angle associated with each of the set of turbine blades 108.

The stress associated with a turbine blade of the set of turbine blades 108 refers to the internal forces per unit area that develop within the turbine blade material when subjected to external loads, such as aerodynamic pressure, gravitational forces, and centrifugal force due to rotation. The strain indicates a deformation of the blade material under stress, defined as the change in shape or size relative to the original dimensions. The operating temperature is a range of ambient and internal temperatures within which the wind turbine 106 and its components, such as the set of turbine blades 108, the wind turbine rotor 112, the generator, and electronics can function reliably. The operating temperature may also indicate the average environmental temperature in which the wind turbine 106 operates. The vibration level refers to the magnitude of oscillatory motion or fluctuations in the structure of the wind turbine 106, particularly in the wind turbine rotor 112, the wind turbine tower 110, and the nacelle. Further, the deflection associated with the turbine blade refers to a displacement of the turbine blade from its original (non-loaded) position due to aerodynamic and centrifugal loads during operation. Moreover, the twist angle of the turbine blade may indicate a variation in the orientation of the chord line of the turbine blade along its length. The power output refers to the amount of electrical power generated by the wind turbine 106, depending on wind speed and turbine characteristics. Wind speed refers to the velocity of air flowing into the wind turbine 106, directly impacting the power output. The turbulence in the wind turbine refers to rapid, irregular variations in wind speed and direction that affect the stability of the operation of the wind turbine 106. Further, the yaw of the wind turbine 106 refers to a rotation of the entire nacelle and the wind turbine rotor 112 about a vertical axis to align the wind turbine 106 with the incoming wind direction. The oscillation of the tower associated with the wind turbine 106 refers to the periodic or non-periodic motion of turbine components, such as the turbine blades 108, the wind turbine tower 110, and the nacelle, due to aerodynamic forces, mechanical imbalances, or environmental factors. Further, the pitch angle of the turbine blade indicates an angle between the chord line of the turbine blade and a rotor plane of the wind turbine rotor 112.

In an embodiment, the one or more sensors 104 may be strategically placed to gather the sensor data on various aspects of the set of turbine blades 108 conditions. The sensor data captured by one or more sensors 104 may be important for assessing the set of turbine blades 108 and further ensuring the efficient operation of the wind turbine 106.

In an example, the one or more sensors 104 may include a light detection and ranging (LIDAR) sensor. The LIDAR sensor may be used to capture the structural characteristics and/or operational characteristics of each of the set of turbine blades 108. Specifically, the LIDAR sensor may scan each of the set of turbine blades 108 and obtain information about their dimension, curvature, stress, strain, vibration, deflection, twist, and the like. This information may help to optimize the set of turbine blades 108 design, improve the power output, and reduce the fatigue and noise of the wind turbine 106. In an embodiment, the LIDAR sensor may be positioned on top of the wind turbine and the LIDAR sensor may be further configured to measure wind speed and turbulence on top of the wind turbine 106, which may be used to adjust the pitch and yaw of the set of turbine blades 108 to maximize the efficiency and stability of the wind turbine 106.

In an embodiment, the one or more sensors 104 may include a Light amplification by the stimulated emission of radiation (LASER) sensor. The LASER may be configured to capture the structural characteristics related to the set of turbine blades 108 based on light amplification techniques. In an embodiment, the LASER-based sensor reflects a technologically advanced approach, emphasizing precision and efficiency in capturing essential information for aerodynamic assessment and performance optimization in the context of the wind turbine 106.

In an embodiment, the one or more sensors 104 may be mounted or positioned on the ground proximal to the wind turbine. This configuration involves the physical installation of the one or more sensors 104 at a ground-level location within the vicinity of the wind turbine 106. By being mounted on the ground, the one or more sensors 104 may be optimally positioned to capture the sensor data associated with each of the set of turbine blades 108 of the wind turbine 106. The ground-mounted arrangement may ensure stability for the one or more sensors 104 and easier accessibility to effectively perform their data collection functions. The configuration caters to ease of maintenance and calibration, and ensures consistent and reliable data acquisition from the set of turbine blades 108, contributing to the overall efficiency and accuracy of the wind turbine 106 monitoring process.

In another embodiment, the one or more sensors 104 may be integrated within an aerial vehicle. Such a configuration involves embedding the one or more sensors 104 directly into an airborne platform, such as a drone or an unmanned aerial vehicle (UAV). By incorporating the one or more sensors 104 within the aerial vehicle, the system 102 gains the advantage of mobility and versatility, allowing it to capture the sensor data associated with each turbine blade of the set of turbine blades 108 from an aerial perspective. This integration offers a dynamic and flexible approach to data collection, enabling the one or more sensors 104 to navigate and adapt to different positions relative to the set of turbine blades 108. The use of the aerial vehicle enhances the system 102 capability to conduct comprehensive assessments efficiently and provides a broader perspective on the aerodynamic profile of the set of turbine blades 108. The airborne integration aligns with modern technological trends, leveraging the advantages of mobility and accessibility for optimizing wind turbine 106 monitoring processes.

Further, the system 102 is configured to determine profile data associated with each of the set of turbine blades 108 based on the sensor data. In this regard, the system 102 may be configured to determine an aerodynamic profile of each of the set of turbine blades 108 based on the sensor data. The aerodynamic profiles may be determined by the system 102 from the captured structural characteristics and operational characteristics from the one or more sensors 104. Through a tailored analytical process, the system 102 interprets and analyzes the sensor data to precisely determine the profile data for each turbine blade of the set of turbine blades 108. The profile data may indicate an aerodynamic profile, such as the aerodynamic parameters of each turbine blade of the set of turbine blades 108. The system 102 translates the captured sensor data to determine the profile data of the set of turbine blades 108. Such systematic interpretation and utilization of the captured sensor data may enable the system 102 to generate accurate profile data, contributing to a comprehensive understanding of the set of turbine blades 108 behavior and facilitating informed decision-making for optimal efficiency of the wind turbine 106.

In an example, the profile data indicates one or more aerodynamic parameters associated with each of the set of turbine blades 108. For example, the one or more aerodynamic parameters of a turbine blade refer to the cross-sectional shape and surface characteristics of the turbine blade along its length, which determine how the turbine blade interacts with airflow during rotation. The one or more aerodynamic parameters of the turbine blade may include, but are not limited to, airfoil shape, chord length, caber, twist angle, pitch angle, thickness distribution, surface condition, taper ratio, and Reynolds number effects.

For example, the airfoil shape may indicate of a cross-section of the turbine blade that may be modeled after airfoil designs used in aerospace engineering (e.g., NACA airfoils). The airfoil shape indicates the blade's ability to generate lift and minimize drag as the wind passes over it. The chord length corresponds to a straight-line distance between a leading edge and a trailing edge of the airfoil at any given cross-section along the turbine blade. The camber may correspond to a curvature of the airfoil's mean line, which affects lift generation. Camber can vary along the turbine blade to optimize performance at different radial positions. The twist angle may indicate a change in the angle of the airfoil along the length of the blade (from root to tip) to maintain an optimal angle of attack relative to the varying relative wind speed across the span of the blade. Further, the pitch angle may indicate an angle between the chord line of the turbine blade and a plane of rotation. This can be fixed or variable (as in pitch-controlled turbines), and it directly affects the angle of attack and aerodynamic efficiency. Further, the thickness indicates a variation in the thickness of the airfoil along the blade span, which impacts structural integrity and aerodynamic characteristics. The surface condition indicates smoothness, roughness, and cleanliness of the turbine blade surface, which affects boundary layer behavior and can influence laminar or turbulent airflow. The taper ratio indicates the ratio of the chord lengths from root to tip. Tapering reduces blade weight and modifies the lift distribution along the span. The Reynolds Number Effect indicates the aerodynamic performance of the airfoil is influenced by the Reynolds number, which varies along the turbine blade due to changing relative velocity and chord length.

Further, the system 102 is configured to determine anomaly data associated with at least one of the set of turbine blades 108 based on the profile data associated with each of the set of turbine blades 108. In an example, the anomaly data indicates a deviation between at least two turbine blades of the set of turbine blades 108. In an example, the system 102 is configured to compare the profile data of the set of turbine blades 108 among each other to determine the anomaly data.

In an example, the set of turbine blades 108 includes the first turbine blade 108A, the second turbine blade 108B, and the third turbine blade 108C. To this end, the wind turbine 106 to have three turbine blades 108 is only exemplary and should not be construed as a limitation. Exemplarily, the set of turbine blades of the wind turbine 106 may include one turbine blade, two turbine blades, or more than three turbine blades.

In this regard, the system 102 is configured to determine first profile data associated with the first turbine blade 108A based on the sensor data. Moreover, the system 102 is configured to determine the second profile data associated with the second turbine blade 108B based on the sensor data. For example, the first profile data may indicate a first aerodynamic profile of the first turbine blade 108A, while the second profile data may indicate a second aerodynamic profile of the second turbine blade 108B. In particular, the first profile data may indicate the first aerodynamic profile based on one or more first aerodynamic parameters of the first turbine blade 108A. Similarly, the second profile data may indicate the second aerodynamic profile based on one or more second aerodynamic parameters of the second turbine blade 108B.

Continuing further, the system 102 may be configured to compare the first profile data with the second profile data. In this regard, the system 102 is configured to conduct a comparison between the profile data of the set of turbine blades 108. In particular, the system 102 is configured to compare the one or more aerodynamic parameters of the first turbine blade 108A and the second turbine blade 108B. For example, the comparison may indicate a deviation in the one or more first aerodynamic parameters of the first turbine blade 108A with respect to the one or more second aerodynamic parameters of the second turbine blade 108B. This may indicate an anomaly or a deviation in one of the first turbine blade 108A or the second turbine blade 108B.

In the same manner, the first profile data of the first turbine blade 108A is compared with the third profile data of the third turbine blade 108C, and the second profile data of the second turbine blade 108B is compared with the third profile data of the third turbine blade 108C.

Based on these comparisons, the anomaly data is determined. In an example, the system 102 is configured to determine the anomaly data based on the comparison between the first profile data and the second profile data. For example, the anomaly data indicates the deviation in at least one of the first turbine blade 108A or the second turbine blade 108B.

In an example, various deviations may be identified. For example, if the comparison may indicate a deviation in first profile data with respect to the second profile data as well as the third profile data, while there exists no deviation between the second profile data and the third profile data, then the anomaly data may indicate a presence of an anomaly, a mismatch, or a deviation in the first turbine blade 108A. To this end, the anomaly data indicates the deviation in at least one of the one or more aerodynamic parameters associated with at least one of the set of turbine blades 108.

Further, the system 102 is configured to output the anomaly data. In an example, the system 102 may be configured to display the output reflecting the anomaly data, i.e., an anomaly or a deviation in the aerodynamic profiles of at least one of the set of turbine blades 108. The output may include the determined variation or discrepancies in a clear and accessible format for understanding by the user 116. The system 102 generates visuals or informational output, providing a comprehensive overview of the identified deviations in the aerodynamic profile of at least one turbine blade of the set of turbine blades 108. The display functionality serves as a valuable tool for the user 116, enabling them to interpret and act upon the observed discrepancies, contributing to the overall management and optimization of the wind turbine 106. The clear presentation of these outputs enhances the system 102 usability and facilitates informed decision-making regarding any necessary adjustment or maintenance activities.

In one embodiment, the user 116 may be empowered to analyze the output generated by the system 102 and subsequently manually correct the aerodynamic parameters of at least one of the set of turbine blades 108. In an embodiment, the user 116 may intervene and apply manual adjustments to rectify or optimize the aerodynamics of the turbine blades 108. This provides a user-driven corrective mechanism, enabling operators or maintenance personnel to implement targeted modifications based on their insights and expertise.

In one embodiment, the system 102 may be empowered to analyze the generated output, providing the capability to correct the aerodynamic parameters of at least one of the set of turbine blades 108 by itself without any manual intervention. This may serve as a dynamic and precise method for aligning and optimizing the aerodynamic parameters of the anomalous turbine blade of the entire set of turbine blades 108, contributing to enhanced operational efficiency and overall performance of wind turbine 106.

In an example, the system 102 may be configured to generate control data associated with the operation of the wind turbine 106. In particular, the control data is generated based on the anomaly data. Further, the system 102 may be configured to control the operation of the wind turbine based on the control data. In an example, based on determining the anomaly data indicating a deviation in the first turbine blade 108A, as well as the deviation to be greater than a threshold, the control data is generated. For example, the control data may include a set of controls to shut down the wind turbine 106 for maintenance, i.e., correction of the deviation. In another example, based on determining the anomaly data indicating a deviation in the first turbine blade 108A, the control data is generated. For example, the control data may include a set of controls to reduce the speed of the operation of the wind turbine 106 or reduce the wind speed at which the wind turbine 106 operates. In certain cases, the control data may include a set of controls to initiate a service request for the correction of the deviation of the first turbine blade 108A. In certain other cases, the control data may include a set of controls to automatically adjust the deviation in the first turbine blade 108A to remove the deviation and restore the first turbine blade 108A to its original or non-anomalous state.

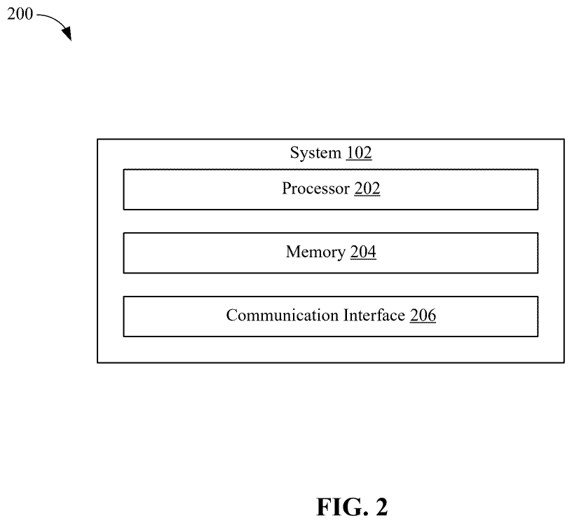

FIG. 2 is an exemplary block diagram 200 of the system 102 of FIG. 1, in accordance with an example embodiment. FIG. 2 is explained in conjunction with elements from FIG. 1. With reference to FIG. 2, there is shown a block diagram 200 of the system 102. The system 102 may include a processor 202, a memory 204, and a communication interface 206.

The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

In an example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment may be accessed using the communication interface 206 of the system 102. The communication interface 206 may provide an interface for accessing various features and data stored in the system 102.

The memory 204 may be non-transitory and may include, for example, one or more volatile and/or non-volatile memories. In other words, for example, the memory 204 may be an electronic storage device (for example, a computer-readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. The memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 may be embodied as an A SIC, FPGA, or the like, the processor 202 may be specifically configured hardware for conducting the operations described herein.

In some example embodiments, the communication interface 206 may be wired, wireless, or any combination of wired and wireless communication networks, such as cellular, Wi-Fi, internet, local area networks, or the like. In some embodiments, the communication interface 206 may include one or more networks such as a data network, a wireless network, a telephony network, or any combination thereof. It may be contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an example, the wireless network may be implemented using, for example, very small aperture terminal (VSAT) communication. The VSAT communication may use satellites to transmit data between ground stations, specifically, in remote areas.

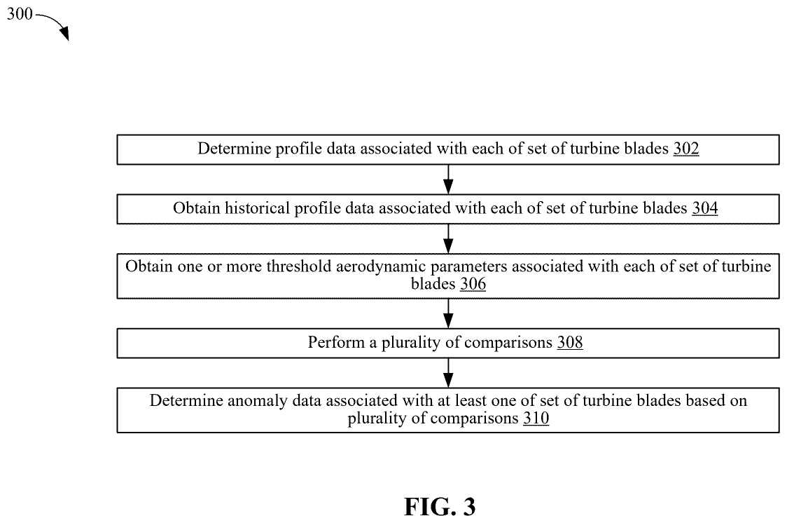

FIG. 3. illustrates a flowchart 300 of a method for determining anomaly data associated with at least one of the set of turbine blades, in accordance with an example embodiment. FIG. 3 is explained in conjunction with elements from FIG. 1, and FIG. 2. The operations of the exemplary method may be executed by any computing system, for example, by the system 102 of FIG. 1 or the processor 202 of FIG. 2. The operations of the flowchart 300 may start at 302.

At 302, profile data associated with each of the set of turbine blades 108 is determined based on the sensor data. In an example, the system 102 is configured to determine the current aerodynamic parameters or current aerodynamic profile of each turbine blade of the set of turbine blades 108 based on the sensor data.

In an example, based on the sensor data, the system 102 is configured to determine first profile data, i.e., first aerodynamic profile, of the first turbine blade 108A, and second profile data, i.e., the second aerodynamic profile, of the second turbine blade 108B, and third profile data, i.e., third aerodynamic profile, of the third turbine blade 108C. The profile data associated with each of the set of turbine blades is determined in real-time based on current or near-recent sensor data.

At 304, historical profile data associated with each of the set of turbine blades is obtained. In an example, the system 102 is configured to obtain the historical profile data associated with each of the set of turbine blades 108. For example, the historical profile data indicates one or more historical aerodynamic parameters associated with each of the set of turbine blades 108.

In an example, the historical profile data of a turbine blade, say the first turbine blade 108A, may indicate a recorded or modeled representation of the one or more historical aerodynamic parameters of the first turbine blade 108A. For example, the one or more historical aerodynamic parameters may correspond to the aerodynamic profile of the first turbine blade 108A as the first turbine blade 108A was originally designed, manufactured, or historically calibrated at specific points in time. The historical profile data serves as a reference or baseline for assessing deviations, degradation, or mismatch that may occur during the operational life of the turbine blade. In a similar manner, historical profile data of each of the second turbine blade 108B and the third turbine blade 108C is also obtained.

For example, the one or more historical aerodynamic parameters in the historical profile data may include, but are not limited to, original airfoil geometry, chord length distribution, twist angle distribution, camber and thickness distribution, pitch angle settings, surface condition metadata, and material property mapping. Moreover, the historical profile data may include measurements of the aerodynamic profile of each of the set of turbine blades 108 during the designing phase (such as simulation data used during development of the turbine blades 108), post-manufacturing phase, installation phase (such as field measurements after installation of the turbine blades 108), and period updates from previous cycles of maintenance or monitoring.

At 306, one or more threshold aerodynamic parameters associated with each of the set of turbine blades are obtained. In an example, the system 102 is configured to obtain the one or more threshold aerodynamic parameters associated with each of the set of turbine blades 108. In an example, the one or more threshold aerodynamic parameters may represent the maximum or minimum acceptable values of specific aerodynamic parameters before performance is degraded or damage may occur.

In an example, the one or more threshold aerodynamic parameters refer to predefined values or acceptable ranges for key aerodynamic parameters of each of the turbine blades 108 of the wind turbine 106. When the value of an aerodynamic parameter exceeds or falls below its threshold limit, it may indicate blade mismatch, performance inefficiency, or structural risk. In an example, the one or more threshold aerodynamic parameters are established based on turbine design specifications, empirical testing, computational models, or operational safety standards, and are used for real-time monitoring, performance assessment, and maintenance decisions.

At 308, a plurality of comparisons is performed. In an example, the system 102 is configured to perform the plurality of comparisons. In this regard, at first, the system 102 is configured to compare the determined current profile data of each of the set of turbine blades 108 among each other. Further, the system 102 is configured to compare the determined current profile data of each of the set of turbine blades 108 with the corresponding historical profile data of the set of turbine blades 108. In addition, the system 102 is configured to compare the determined current profile data of each of the set of turbine blades 108 with the corresponding one or more aerodynamic parameters.

In the first example, the system 102 is configured to compare the determined profile data of each of the set of turbine blades with each other. For example, the system 102 is configured to determine the first profile data indicating one or more first aerodynamic parameters, i.e., a current aerodynamic profile, of the first turbine blade 108A. Similarly, the system 102 is configured to determine the second profile data indicating one or more second aerodynamic parameters, i.e., a current aerodynamic profile, of the second turbine blade 108B. The system 102 is configured to determine the third profile data indicating one or more third aerodynamic parameters, i.e., a current aerodynamic profile, of the third turbine blade 108C. Further, the system 102 is configured to compare the first profile data with the second profile data. Similarly, the system 102 is configured to compare the first profile data with the third profile data, as well as the second profile data with the third profile data.

In a second example, the system 102 is configured to compare the determined profile data of each of the set of turbine blades 108 with the corresponding historical profile data. In an example, the historical profile data may include one or more first historical aerodynamic parameters associated with the first turbine blade 108A, one or more second historical aerodynamic parameters associated with the second turbine blade 108B, and one or more third historical aerodynamic parameters associated with the third turbine blade 108C. Subsequently, the first profile data or the one or more first aerodynamic parameters of the first turbine blade 108A is compared with the one or more first historical aerodynamic parameters. Further, the second profile data or the one or more second aerodynamic parameters of the second turbine blade 108B is compared with the one or more second historical aerodynamic parameters; and the third profile data or the one or more first aerodynamic parameters of the third turbine blade 108C is compared with the one or more third historical aerodynamic parameters.

In a third example, the system 102 is configured to compare the determined profile data of each of the set of turbine blades 108 with the corresponding one or more threshold aerodynamic parameters. In an example, one or more first threshold aerodynamic parameters may correspond to the first turbine blade 108A, one or more second threshold aerodynamic parameters may correspond to the second turbine blade 108B, and one or more third threshold aerodynamic parameters may correspond to the third turbine blade 108C. Subsequently, the first profile data or the one or more first aerodynamic parameters of the first turbine blade 108A is compared with the one or more first threshold aerodynamic parameters. Further, the second profile data or the one or more second aerodynamic parameters of the second turbine blade 108B is compared with the one or more second threshold aerodynamic parameters, and the third profile data or the one or more third aerodynamic parameters of the third turbine blade 108C is compared with the one or more third threshold aerodynamic parameters.

It may be noted that, in some cases, each of the above-mentioned plurality of comparisons may be performed. For example, such comparisons may be performed sequentially. In certain other cases, some of the plurality of comparisons may be performed. Such selection of which comparisons to perform may be based on, for example, predefined standards, specifics of the wind turbine 106, and/or data availability.

At 310, anomaly data associated with at least one of the set of turbine blades is determined based on the plurality of comparisons. In an example, the system 102 is configured to determine the anomaly data associated with a deviation in at least one of the set of turbine blades 108 based on the plurality of comparisons.

In the first example, the anomaly data may be determined based on the comparison of determined current profile data of each of the set of turbine blades among each other. For example, if the first profile data matches the second profile data, the second profile data matches the third profile data, and the third profile data matches the first profile data, then the anomaly data may indicate that there is no deviation in any of the set of turbine blades 108. Thus, there is no anomaly or deviation in any one of the set of turbine blades 108. However, if the first profile data does not match the second profile data, the second profile data matches the third profile data, and the third profile data does not match the first profile data, then the anomaly data may indicate that there exists a deviation or an anomaly in either the first turbine blade 108A, or the second turbine blade 108B and the third turbine blade 108C. In order to accurately identify the anomaly or deviation in the set of turbine blades 108, the system 102 is further configured to determine the anomaly data based on other comparisons, such as described in the second example and the third example.

In the second example, the anomaly data may be determined based on the comparison of determined current profile data of each of the set of turbine blades with the corresponding historical profile data. For example, if the first profile data matches the first historical profile data of the first turbine blade 108A, then the anomaly data may indicate that there is no deviation in the first turbine blade 108A. However, if the first profile data does not match with the first historical profile data of the first turbine blade 108A, then the anomaly data may indicate that there is a deviation or an anomaly in the first turbine blade 108A. Such a comparative analysis is achieved by leveraging the previously determined aerodynamic profile of each turbine blade of the set of turbine blades 108. The system 102 may systematically evaluate the nuanced aerodynamic characteristics of each of the first turbine blade 108A, the second turbine blade 108B, and the third turbine blade 108C, aiming to discern any variations or similarities between them. Such comparison enables the system 102 to effectively identify and quantify the deviation or consistencies in the aerodynamic parameters or aerodynamic profile of each turbine blade of the set of turbine blades 108.

In order to further improve the accuracy of the anomaly data, in the third example, the system 102 may be configured to determine the anomaly data based on the comparison between the determined profile data of each of the set of turbine blades 108 with the one or more threshold aerodynamic parameters. For example, the one or more threshold aerodynamic parameters for a turbine blade may indicate a reference aerodynamic profile for the turbine blade. To perform this comparison, for example, the first profile data, i.e., the one or more first aerodynamic parameters, are aligned with the one or more first threshold aerodynamic parameters associated with the first turbine blade 108A to determine similarity or deviation therein. The one or more first threshold aerodynamic parameters represents an optimal or an ideal aerodynamic profile for the first turbine blade 108A. Based on the comparison, the system 102 may identify any deviations or discrepancies between the actual aerodynamic profile and the expected standard aerodynamic profile. This serves as a robust validation mechanism, providing an objective basis for evaluating the accuracy and efficiency of determine profile data of each of the set of turbine blades 108 within the wind turbine 106.

In one embodiment, profile data, say the first profile data may indicate the one or more first aerodynamic parameters of the first turbine blade 108A. Such one or more first aerodynamic parameters may be used to design or generate a first model of the first turbine blade 108A. Moreover, the first historical data may be used to generate a first historical model of the first turbine blade 108A, while the one or more first threshold aerodynamic parameters may be used to generate a first reference model of the first turbine blade 108A. Further, the comparison between the first profile data and the first historical profile data is performed by overlapping the first model of the first turbine blade 108A on the first historical model of the first turbine blade 108A. Similarly, the comparison between the first profile data and the one or more first threshold aerodynamic parameters is performed by overlapping the first model of the first turbine blade 108A on the first reference model of the first turbine blade 108A. Based on the overlap, any deviation may be identified as an anomaly and corresponding data is determined as anomaly data.

Similarly, a second model is generated for the second turbine blade 108B and a third model is generated for the third turbine blade 108C. For example, the system 102 may be configured to determine the anomaly data based on an overlap of the generated second model or the third model on corresponding historical models and/or corresponding reference models. This may involve an alignment of the aerodynamic parameters of each of the set of turbine blades 108 with the corresponding one or more threshold aerodynamic parameters or the corresponding one or more historical aerodynamic parameters for detailed comparison. Subsequently, the system 102 may be configured to execute the plurality of comparisons based on the overlapping of the models or aerodynamic profiles of the set of turbine blades 108. This may offer a nuanced evaluation by directly superimposing the aerodynamic profile, enabling a comprehensive assessment of their similarities or disparities. The overlapping method, performed by the system 102, may contribute to a more refined analysis, providing valuable insight into the aerodynamic profile of the individual turbine blade within the wind turbine 106.

Further, the system 102 may be configured to analyze and determine the anomaly data, i.e., deviations in either the first turbine blade 108A, the second turbine blade 108B or the third turbine blade 108C or in all the turbine blades 108 of the wind turbine 106 by leveraging the outcomes of the plurality of comparisons. The deviation in the aerodynamic profile of the set of turbine blades 108 may correspond to a difference between an actual shape of the turbine blade and the ideal or optimal shape of the turbine blade. The deviation may be caused by various factors, such as blade deformation, rotation effect, tower shadow effect, wind speed, turbulence, etc., and may affect the lift and drag forces on the set of turbine blades 108, as well as the power output and reliability of the wind turbine 106. Therefore, it is important to measure and minimize the deviation in the aerodynamic profile of the set of turbine blades 108 to optimize the efficiency and stability of the wind turbine 106. Further, through a specialized configuration, the system 102 evaluates the differences or the variation identified during the comparison of the profile data of the set of turbine blade 108. This analysis enables the system 102 to pinpoint specific disparities in the aerodynamic parameters of at least one of the set of turbine blades 108. By scrutinizing the comparison results, the system 102 precisely identifies and quantifies any deviation, providing valuable insights into how the aerodynamic profile of each of the set of turbine blades 108 may differ from the expected standards. This deviation determination may be an important step in the functionality of the system 102, offering a clear indication of the set of turbine blades 108 performance relative to the predefined benchmarks or reference aerodynamic profile.

In one embodiment, the determined anomaly data or the deviation in the first turbine blade 108A serves as a key indicator, pointing towards a misalignment in the one or more first aerodynamic parameters concerning the aerodynamic profile of the first turbine blade 108A. This identified deviation implies a significant discrepancy between the aerodynamic parameters of the first turbine blade 108A and aerodynamic parameters of the second turbine blade 108B or the third turbine blade 108C. The anomaly data highlights the difference from the expected optimal or ideal alignment. The system 102, through its comparison process, discerns variations in lift, thrust, or other aerodynamic parameters that contribute to the observed deviation. The system 102 may be configured to precisely pinpoint the aerodynamic mismatch may be important, as it allows operators and maintenance personnel to address and rectify the specific issues causing the deviation. By understanding the nature of the misalignment, corrective measures may be implemented, such as manual adjustments or calibration, to ensure that both turbine blades 108 operate cohesively and contribute effectively to the overall efficiency of the wind turbine 106.

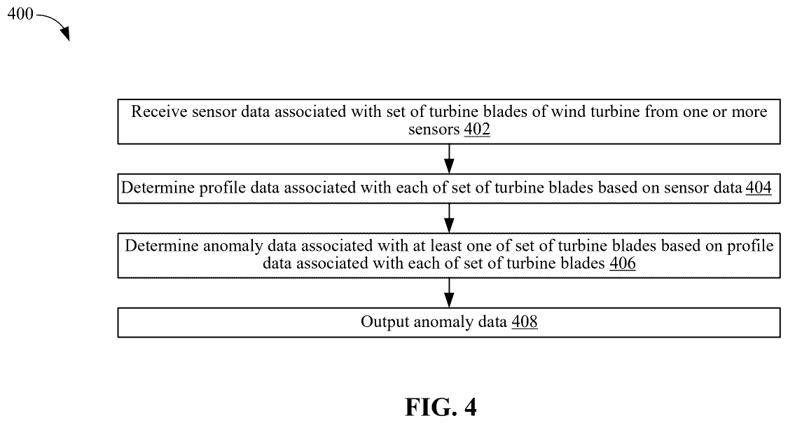

FIG. 4. illustrates a flowchart 400 of a method for anomaly data output associated with at least one of a set of turbine blades, in accordance with an example embodiment. FIG. 4 is explained in conjunction with elements from FIG. 1, FIG. 2, and FIG. 3. The operations of the exemplary method may be executed by any computing system, for example, by the system 102 of FIG. 1 or the processor 202 of FIG. 2. The operations of the flowchart 400 may start at 402.

At 402, sensor data associated with a set of turbine blades of a wind turbine is received. In an example, the system 102 is configured to receive the sensor data associated with the set of turbine blades 108 from the one or more sensors 104. The sensor data indicates one or more structural characteristics associated with each of the set of turbine blades 108 and/or one or more operational characteristics associated with each of the set of turbine blades 108. In an example, the one or more sensors 104 includes a LIDAR sensor and/or a LASER sensor.

For example, the one or more structural characteristics corresponds to a dimension associated with each of the set of turbine blades 108, a curvature associated with each of the set of turbine blades 108, or one or more material parameters associated with each of the set of turbine blades 108. Moreover, the one or more operational characteristics corresponds to a stress associated with each of the set of turbine blades 108, a strain associated with each of the set of turbine blades 108, an operational temperature associated with the wind turbine 106, a vibration level associated with each of the set of turbine blades 108, a deflection associated with each of the set of turbine blades 108, a twist angle associated with each of the set of turbine blades 108, a power output associated with the wind turbine 106, a wind speed associated with the wind turbine 106, a turbulence associated with the wind turbine 106, a yaw associated with the wind turbine 106, an oscillation of the wind turbine tower 110 associated with the wind turbine 106, or a pitch angle associated with each of the set of turbine blades 108.

At 404, profile data associated with each of the set of turbine blades 108 is determined based on the sensor data. In an example, the system 102 is configured to determine the profile data associated with each of the set of turbine blades 108 based on the sensor data. For example, the profile data of a turbine blade indicates one or more aerodynamic parameters associated with the turbine blade of the set of turbine blades 108. In particular, the one or more aerodynamic parameters of the turbine blade may represent a current aerodynamic profile of the turbine blade.

At 406, anomaly data associated with at least one of the set of turbine blades is determined. In an example, the system 102 is configured to determine the anomaly data associated with at least one of the set of turbine blades 108 based on the profile data associated with each of the set of turbine blades 108. For example, the anomaly data indicates a deviation between at least two turbine blades of the set of turbine blades 108. The anomaly data indicates the deviation in at least one of the one or more aerodynamic parameters associated with at least one of the set of turbine blades. In an example, the anomaly data may indicate a deviation in an aerodynamic parameter, such as pitch angle or surface condition, of the first turbine blade 108A with respect to the same aerodynamic parameter of the second turbine blade 108B.

At 408, the anomaly data is output. In an example, the system 102 is configured to output the anomaly data. In an example, the anomaly data is output on a display screen. In another example, the anomaly data is output to a downstream module, such as a control module of the wind turbine 106 to control operations of the wind turbine 106. Based on the output of the anomaly data, certain operations of the wind turbine 106 may be controlled to ensure safe and reliable operation of the wind turbine 106.

To this end, the wind turbine 106 may be equipped with sophisticated control systems, i.e., the system 102, that continuously monitor the sets of turbine blades 108. For example, the system may also dynamically alter the pitch angle and/or the angle of attack of the set of turbine blades 108 to maintain an optimal aerodynamic profile, even in the face of varying wind conditions. By ensuring that the set of turbine blades 108 operates with the same aerodynamic profile, the system 102 helps to minimize acceleration and vibration, thereby enhancing the reliability and performance of the wind turbine 106.

Moreover, optimizing the pitch angle of the set of turbine blades 108 may lead to considerable improvements in performance. This highlights the importance of precise blade angle control in maximizing the efficiency of the wind turbine 106.

In conclusion, maintaining a consistent aerodynamic profile across all of the set of turbine blades 108 may be essential for the stable and efficient operation of the wind turbine 106. Any deviation in the set of turbine blades 108 angles may lead to increased acceleration and vibration, which may compromise the performance and safety of the wind turbine 106. Through the described system 102 into aerodynamic optimization, the wind energy industry continues to improve the reliability and efficiency of wind turbines, ensuring their role as a key component in the transition to sustainable energy sources.

Many modifications and other embodiments of the inventions set forth herein will come to mind to one skilled in the art to which these inventions pertain having the benefit of the teachings presented in the foregoing descriptions and the associated drawings. It is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed:

1. A system, comprising:
a memory configured to store computer-executable instructions; and
one or more processors configured to execute the computer-executable instructions to:
receive, from one or more sensors, sensor data associated with a set of turbine blades of a wind turbine, wherein the sensor data indicates at least one of: one or more structural characteristics associated with each of the set of turbine blades, or one or more operational characteristics associated with each of the set of turbine blades;
determine profile data associated with each of the set of turbine blades based on the sensor data;
determine anomaly data associated with at least one of the set of turbine blades based on the profile data associated with each of the set of turbine blades, wherein the anomaly data indicates a deviation between at least two turbine blades of the set of turbine blades; and
output the anomaly data.

2. The system of claim 1, wherein the set of turbine blades comprises at least a first turbine blade and a second turbine blade, and wherein the one or more processors are further configured to:
determine first profile data associated with the first turbine blade based on the sensor data;
determine second profile data associated with the second turbine blade based on the sensor data;
compare the first profile data with the second profile data; and
determine the anomaly data based on the comparison between the first profile data and the second profile data, wherein the anomaly data indicates the deviation in at least one of the first turbine blade or the second turbine blade.

3. The system of claim 1, wherein the one or more processors are further configured to:
obtain historical profile data associated with each of the set of turbine blades, wherein the historical profile data indicates one or more historical aerodynamic parameters associated with each of the set of turbine blades;
compare the profile data associated with each of the set of turbine blades with the corresponding historical profile data; and
determine the anomaly data associated with at least one of the set of turbine blades based on the comparison between the profile data and the historical profile data.

4. The system of claim 1, wherein the one or more processors are further configured to:
generate control data associated with an operation of the wind turbine, wherein the control data is generated based on the anomaly data; and
cause to control the operation of the wind turbine based on the control data.

5. The system of claim 1, wherein the profile data indicates one or more aerodynamic parameters associated with each of the set of turbine blades.

6. The system of claim 5, wherein the one or more processors are further configured to:
obtain one or more threshold aerodynamic parameters associated with each of the set of turbine blades;
compare the one or more aerodynamic parameters associated with each of the set of turbine blades with the corresponding one or more threshold aerodynamic parameters; and
determine the anomaly data associated with at least one of the set of turbine blades based on the comparison between the one or more aerodynamic parameters and the one or more threshold aerodynamic parameters.

7. The system of claim 5, wherein the anomaly data indicates the deviation in at least one of the one or more aerodynamic parameters associated with at least one of the set of turbine blades.

8. The system of claim 1, wherein the one or more structural characteristics corresponds to at least one of: a dimension associated with each of the set of turbine blades, a curvature associated with each of the set of turbine blades, or one or more material parameters associated with each of the set of turbine blades.

9. The system of claim 1, wherein the one or more operational characteristics corresponds to at least one of: a stress associated with each of the set of turbine blades, a strain associated with each of the set of turbine blades, an operational temperature associated with the wind turbine, a vibration level associated with each of the set of turbine blades, a deflection associated with each of the set of turbine blades, a twist angle associated with each of the set of turbine blades, a power output associated with the wind turbine, a wind speed associated with the wind turbine, a turbulence associated with the wind turbine, a yaw associated with the wind turbine, an oscillation of a tower associated with the wind turbine, or a pitch angle associated with each of the set of turbine blades.

10. The system of claim 1, wherein the one or more sensors comprises at least one of:
a Light Detection and Ranging (LIDAR) sensor, or a Light amplification by stimulated emission of radiation (LASER) sensor.

11. The system of claim 1, wherein the one or more sensors are mounted on ground proximal to the wind turbine.

12. The system of claim 1, wherein the one or more sensors are integrated within an aerial vehicle.

13. A method, comprising:
receiving sensor data associated with a set of turbine blades of a wind turbine, wherein the sensor data indicates at least one of: one or more structural characteristics associated with each of the set of turbine blades, or one or more operational characteristics associated with each of the set of turbine blades;
determining profile data associated with each of the set of turbine blades based on the sensor data;
determining anomaly data associated with at least one of the set of turbine blades based on the profile data associated with each of the set of turbine blades, wherein the anomaly data indicates a deviation between at least two turbine blades of the set of turbine blades; and
outputting the anomaly data.

14. The method of claim 13, wherein the set of turbine blades comprises at least a first turbine blade and a second turbine blade, and wherein the method further comprises:
determining first profile data associated with the first turbine blade based on the sensor data;
determining second profile data associated with the second turbine blade based on the sensor data;
comparing the first profile data with the second profile data; and
determining the anomaly data based on the comparison between the first profile data and the second profile data, wherein the anomaly data indicates the deviation in at least one of the first turbine blade or the second turbine blade.

15. The method of claim 13, wherein the method further comprises:
obtaining historical profile data associated with each of the set of turbine blades, wherein the historical profile data indicates one or more historical aerodynamic parameters associated with each of the set of turbine blades;
comparing the profile data associated with each of the set of turbine blades with the corresponding historical profile data; and
determining the anomaly data associated with at least one of the set of turbine blades based on the comparison between the profile data and the historical profile data.

16. The method of claim 13, wherein the method further comprises:
generating control data associated with an operation of the wind turbine, wherein the control data is generated based on the anomaly data; and
causing to control the operation of the wind turbine based on the control data.

17. The method of claim 13, wherein the profile data indicates one or more aerodynamic parameters associated with each of the set of turbine blades.

18. The method of claim 17, wherein the method further comprises:
obtaining one or more threshold aerodynamic parameters associated with each of the set of turbine blades;
comparing the one or more aerodynamic parameters associated with each of the set of turbine blades with the corresponding one or more threshold aerodynamic parameters; and
determining the anomaly data associated with at least one of the set of turbine blades based on the comparison between the one or more aerodynamic parameters and the one or more threshold aerodynamic parameters.

19. The method of claim 17, wherein the anomaly data indicates the deviation in at least one of the one or more aerodynamic parameters associated with at least one of the set of turbine blades.

20. A computer programmable product comprising a non-transitory computer readable medium having stored thereon computer executable instructions, which when executed by one or more processors, cause the one or more processors to carry out operations comprising:
receiving sensor data associated with a set of turbine blades of a wind turbine, wherein the sensor data indicates at least one of: one or more structural characteristics associated with each of the set of turbine blades, or one or more operational characteristics associated with each of the set of turbine blades;
determining profile data associated with each of the set of turbine blades based on the sensor data;
determining anomaly data associated with at least one of the set of turbine blades based on the profile data associated with each of the set of turbine blades, wherein the anomaly data indicates a deviation between at least two turbine blades of the set of turbine blades; and
outputting the anomaly data.
